(19) United States
(12) Patent Application Publication
(10) Pub. No.: US 2020/0162000 A1
(43) Pub. Date: May 21, 2020

(54) REDUCING MOISTURE USING ELECTRICAL CURRENT

(71) Applicant: Cummins Power Generation IP, Inc., Minneapolis, MN (US)

(72) Inventor: Dan G. Priem, Brooklyn Center, MN (US)

(73) Assignee: Cummins Power Generation IP, Inc., Minneapolis, MN (US)

(21) Appl. No.: 16/657,611

(22) Filed: Oct. 18, 2019

Related U.S. Application Data
(63) Continuation of application No. 15/006,791, filed on Jan. 26, 2016, now abandoned.

(51) Int. Cl. H02P 9/00; H02K 11/33; H02K 11/20; H02P 29/62; H02K 15/12

(52) U.S. Cl. CPC H02P 9/006; H02K 11/33; H02K 15/125; H02P 29/62; H02K 11/20

(57) ABSTRACT

Systems and methods that utilize continuous field flash as integrated alternator heaters in a genset are disclosed herein. The method includes detecting that a generator set is in a non-rotating state, enabling a field flash circuit of the generator set to operate while the generator set is in the non-rotating state, and activating the field flash circuit so that current flows through and heats at least a portion of an alternator of the generator set and reduces a moisture on the at least a portion of the generator set.

### CROSS-REFERENCE TO RELATED APPLICATIONS

The present application is a continuation of U.S. application Ser. No. 15/006,791, filed Jan. 26, 2016, the content of which is hereby incorporated by reference in its entirety.

### TECHNICAL FIELD

The present application relates to generator sets (gensets). More particularly, the present application relates to systems and methods for removing moisture from gensets.

### BACKGROUND

When internal components of a genset, such as alternator windings and brush blocks, are exposed to moisture, the components may be corroded, and their functions may be affected. Moisture on gensets can cause undesirable flows of current on the insulation that typically covers windings. These flows of current, due to moisture, may produce partially conducting paths as a result of electric leakage on the insulation surface, which can lead to low insulation values and eventual failure. One solution is to provide an alternator heater that works to raise the temperature of windings and drive moisture out of the genset. The heater(s) may draw power from an auxiliary power source. However, alternator heaters can have a relatively high failure rate and may not be effective at driving moisture from the alternator windings and the brush blocks.

### SUMMARY

One embodiment relates to a method including detecting that a generator set is in a non-rotating state, enabling a field flash circuit of the generator set to operate while the generator set is in the non-rotating state, wherein the field flash circuit is structured to provide a field flash current to the generator set, and activating the field flash circuit so that current flows through and heats at least a portion of an alternator of the generator set and reduces a moisture on the at least a portion of the generator set.

Another embodiment relates to a system including a circuitry configured to detect that a generator set is in a non-rotating state, enable a field flash circuit of the generator set to operate while the generator set is in the non-rotating state, wherein the field flash circuit is structured to provide a field flash current to the generator set, and activate the field flash circuit so that current flows through and heats at least a portion of an alternator of the generator set and reduces a moisture on the at least a portion of the generator set.

Still another embodiment relate to a genset comprising an engine, a generator operatively connected to the engine, a field flash circuit structured to provide a field flash current to the generator, and a controller. The controller is configured to detect that the generator set is in a non-rotating state, enable the field flash circuit to operate while the generator set is in the non-rotating state, and activate the field flash circuit so that current flows through and heats at least a portion of an alternator of the generator set and reduces a moisture on the at least a portion of the generator set.

These and other features, together with the organization and manner of operation thereof, will become apparent from the following detailed description when taken in conjunction with the accompanying drawings.

### BRIEF DESCRIPTION OF THE DRAWINGS

FIG. 1 is a schematic diagram of a genset including a field flash circuit operating as an alternator heater.

FIG. 2(a) is a schematic diagram of a portion of an operator panel of FIG. 1 in which a Start mode is selected.

FIG. 2(b) is a schematic diagram of a portion of the operator panel in which an Off mode is selected.

FIG. 2(c) is a schematic diagram of a portion of the operator panel in which an Auto/Remote mode is selected.

FIG. 3 is a schematic diagram of a controller usable in the genset of FIG. 1.

FIG. 4 is a flow chart for operating the genset of FIG. 1.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

A generator set (genset) includes a rotor that generates a moving magnetic field around a stator, which induces a voltage difference between windings of the stator. This produces an alternating current (AC) output of the genset. Moisture can sometimes accumulate on the internal components of a genset, such as stator windings and brush blocks. If the moisture is not reduced or removed, over time, the components may be corroded and/or their functions may be affected. An alternator heater may sometimes be used to raise the temperature of windings and drive moisture out. However, alternator heaters often have a relatively high failure rate and may not be effective at driving moisture from the alternator windings and the brush blocks.

For a genset using a rotor with field coils, a magnetic field may be generated by causing a current to flow in the field coils. The rotor retains a magnetism when the genset is turned off. When the genset is started again, the residual magnetism can create an initial voltage in the stator windings, which in turn increases the field current until the genset builds up to full voltage. However, over time, the genset may lose magnetism after long periods of storage and may not retain enough residual magnetism to activate the genset. If the rotor does not have enough residual magnetism to build up to full voltage, a “field flash” circuit may be used to inject a field flashing current into the rotor.

Referring to the figures generally, various embodiments disclosed herein relate to systems and methods that utilize field flashing (e.g., a continuous field flash) as a way to heat components and reduce moisture in a genset as a replacement for or supplement to a separate alternator heater. In particular, when the genset is not running, or in a non-rotating state, the field flash circuit may be enabled so as to provide a heat source to internal components of the generator to reduce moisture and prevent corrosion. When the genset is running, the field flash circuit may be disabled. The field flash circuit may be selectively activated based on the time of a day, the temperature, the humidity, etc. In some implementations, the field flash circuit may be activated based at least in part on a real-time temperature and/or humidity (e.g., a temperature and/or humidity measured no more than a predetermined time before the field flash circuit is activated). Embodiments disclosed herein may provide an integrated heat source to remove moisture without adding extra parts to the genset using a field flash circuit that is already in place for field flashing. As such, an integrated alternator heater with low cost, low energy consumption, and improved reliability is provided.

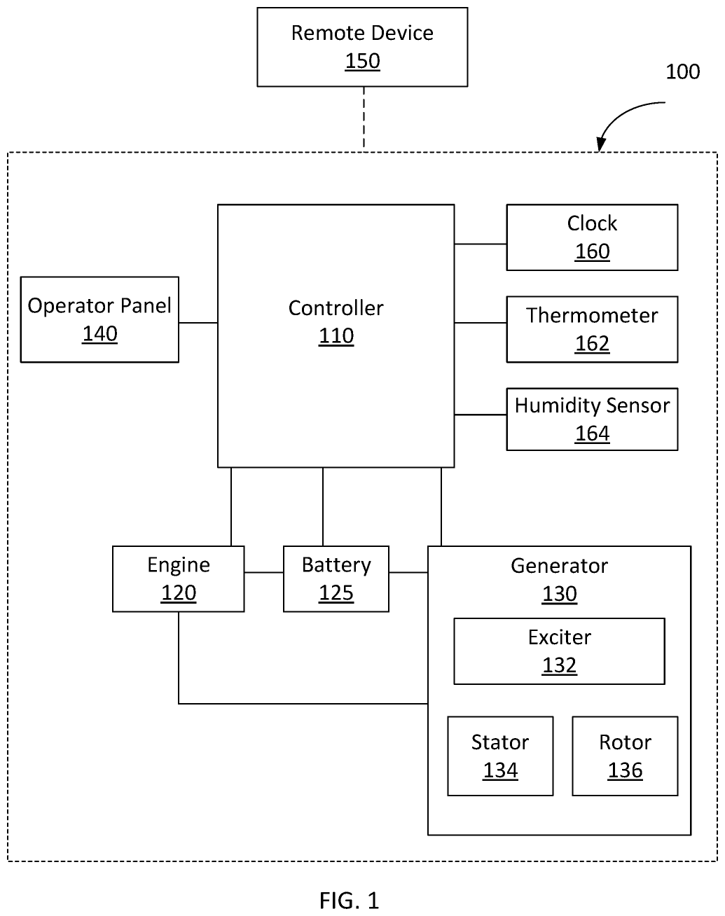

Referring to FIG. 1, a schematic diagram of a genset 100 including a field flash circuit operating as an integrated alternator heater is shown according to an exemplary embodiment. The genset 100 may include an engine 120 that provides mechanical energy to drive a generator 130 to produce electrical power. The engine 120 may be a gas turbine engine, a gasoline engine, a diesel engine, or any other engine capable of supplying mechanical power to drive the generator 130.

The generator 130 may produce electrical power from the mechanical input supplied by the engine 120. The generator 130 may include a rotor 136, a stator 134, and an exciter 132 and, optionally, other components. The rotor 136 may generate a moving magnetic field around the stator 134, which induces a voltage across windings of the stator 134, thereby producing the AC output. The rotor 136 may be driven by an alternator pulley (not illustrated in the present Figure), rotating as the engine 120 runs. In some embodiments, the rotor 136 includes a coil of wire wrapped around an iron core. As discussed above, for a rotor using a field coil, a field current may be supplied during operation of the genset in order to generate the moving magnetic field. The level of the field current determines the strength of the magnetic field. The exciter 132 supplies the field current. When the field current passes into the rotor 136, a magnetic field is generated. The stator 134 may include multiple windings of wire that are fixed to a shell of the generator 130 and surrounding around the rotor 136. As the rotor 136 spins within the windings of the stator 134, the magnetic field of the rotor 136 sweeps through the windings, producing an electrical current in the windings. The exciter 132 may supply field flashing current in a genset starting sequence and draw voltage from the generator 130 in a running state. The exciter 132 may be a static-type exciter, a brush-type exciter, a brushless-type exciter, or any suitable type of exciter. It shall also be appreciated that the configuration of the generator 130 shown in FIG. 1 is provided for purposes of illustration only. Other embodiments may include fewer, more, or different components than those illustrated in FIG. 1

The genset 100 may include a battery 125 from which the exciter 132 receives the field flash voltage. The battery 125 may be a rechargeable battery that supplied a voltage at 12 VDC. The battery 125 may be charged by the generator 130 when the genset 100 is running.

The genset 100 may include an operator panel 140 that serves as a user interface of the genset 100. The operator panel 140 may be configured to convey information to a user on a display (not illustrated in the present figures) and to receive a user input via, for example, a keypad, switches, and/or buttons. The user input may also be transmitted from a remote device 150. In some embodiments, the remote device 150 comprises a transfer switch at a remote location or a remote computing device. The operator panel 140 is communicably coupled with the controller 110 that is responsive to command signals generated through the operator panel 140.

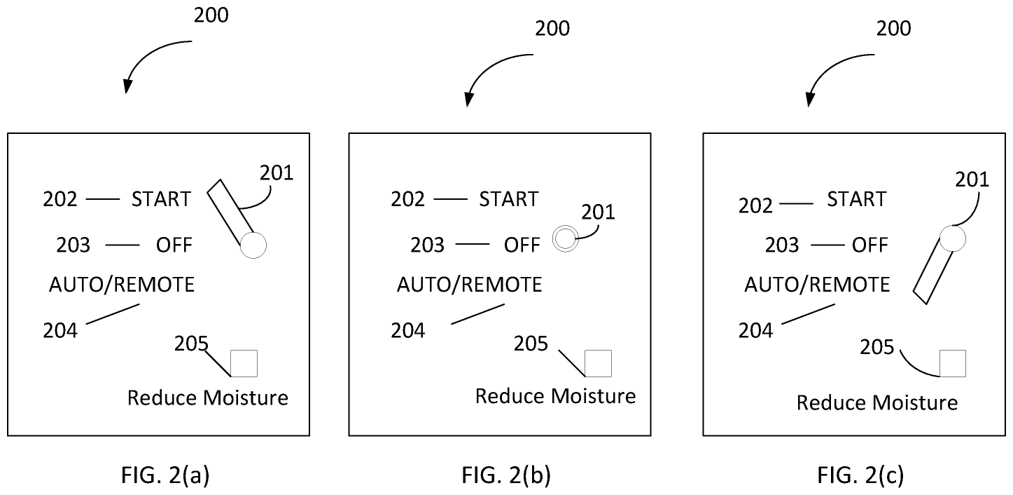

Referring to FIGS. 2(a) through 2(c), schematic diagrams of a portion of the operator panel 200 are shown according to an exemplary embodiment. The operator panel 200 may be used on, for example, the genset 100 shown in FIG. 1. The operator panel 200 includes, among others, a three-position rocker switch 201 to operate the genset 100. The rocker switch 201 can be used to select one of three operating modes, namely, “Start,” “Off,” and “Auto/Remote.” The rocker switch 201 may also include a lamp indicating genset running and genset fault codes. The Start mode may be enabled by moving the rocker switch 201 to a top position 202, as shown in FIG. 2(a). In the Start mode, operation of the genset 100 is activated. For example, the engine 120 may begin cranking, and may start after a few seconds. The Off mode may be enabled by moving the rocker switch 201 to a middle position 203, as shown in FIG. 2(b). In the Off mode, the genset 100 may be shut down (if running), and any faults may be reset. The Auto/Remote mode may be enabled by moving the rocker switch 201 to a bottom position 204, as shown in FIG. 2(c). In the Auto/Remote mode, operation of the genset 100 may be activated and/or deactivated automatically in response to one or more monitored conditions. For example, electrical power provided by a utility may be monitored, and, if the commercial electrical power from the utility fails, the engine 120 of the electrical generator may be automatically started causing the generator 130 to generate electrical power. When the electrical power generated by the genset 100 reaches a predetermined voltage, a transfer switch may switch a load to the genset 100 from utility power lines. In some embodiments, the Auto/Remote mode may additionally or alternatively allow activation and/or deactivation of the genset 100 in response to a signal received from a location remote from the genset 100 (e.g., from a remote device 150 such as a remote transfer switch, a mobile computing device, remote desktop computing device, etc.). If the controller 110 receives a start signal from the remote device 150 (e.g., a transfer switch or a mobile computing device), the genset 100 may be started. If the controller 110 receives a stop signal from the remote device 150, the genset 100 may be shut down.

The operator panel 200 may include a “Reduce Moisture” button 205. The button 205 may only be pressed when the genset 100 is not running, or in a non-rotating state, in some embodiments. In other words, if the “Start” mode is selected, the button 205 cannot be pressed. When the button 205 is pressed, the field flashing is applied to a portion of the alternator to reduce moisture thereon. It shall be appreciated that the configuration of the operator panel 200 shown in FIGS. 2(a) through 2(c) is provided for purposes of illustration only. Other embodiments may include fewer, more, or different components than those illustrated in FIG. 2. For example, the operator panel 200 may display genset fault messages, time, temperature, humidity, warning, mode, and other information to a user. Different manufacturers may have varied features to offer in the control panel 200.

The genset 100 may further include a clock 160 structured to maintain the current time, a thermometer 162 or other temperature sensor structured to measure a temperature of one or more components of the genset 100 (e.g., a real-time temperature), and/or a humidity sensor 164 structured to measure a humidity near one or more components of the genset 100 (e.g., a real-time humidity). In some embodiments, the thermometer 162 and/or the humidity sensor 164 is embedded in the windings or an alternator assembly of the generator 130. The clock 160, the thermometer 162, and the humidity sensor 164 may be structured to generate signals indicative of time, temperature, and humidity for the use of the controller 110 in controlling operation of the genset 100.

The genset 100 may further include a controller 110 that may perform functions of the genset 100 (e.g., activating and deactivating the genset 100). The controller 110 may be communicably coupled with the operator panel 140 and may respond to command signals (i.e., Start, Off, Auto/Remote, and “Reduce Moisture”) generated through the operator panel 140. The controller 110 may cause the operator panel 140 to display information such as fault messages, time, temperature, humidity, etc. The controller 110 may be communicably coupled with and control operations of the engine 120 and the generator 130. Communication between the controller 110 and various components of the genset 100 may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (CAN) bus provides the exchange of signals, information, and/or data. The CAN bus may include any number of wired and wireless connections.

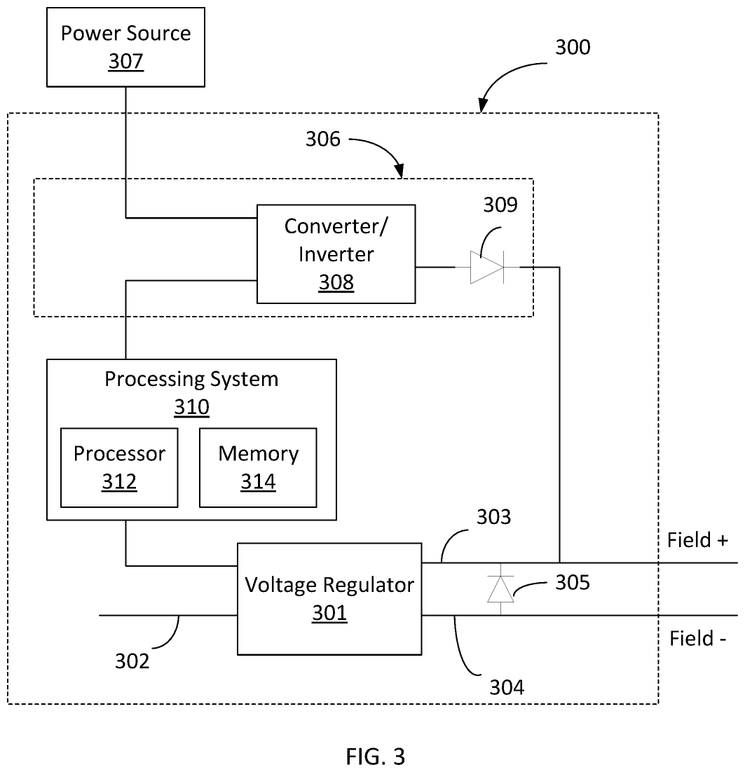

Referring to FIG. 3, a schematic diagram of a controller 300 is shown according to an exemplary embodiment. The controller 300 may be used on the genset 100 shown in FIG. 1. The controller 300 includes, among others, a voltage regulator 301, a field flash circuit 306, and a processing system 310 communicably connected with the voltage regulator 301 and the field flash circuit 306. The voltage regulator 301 may regulate the output voltage of the generator 130. As discussed above, the level of the field current determines the strength of the magnetic field, thereby determining the output voltage of the generator 130. When the engine 120 is started, the residual magnetism retained in the rotor 136 may be sufficient to create an initial voltage in the windings of the stator 134, which in turn increases the field current until the generator 130 builds up to full voltage. If the rotor 136 does not have enough residual magnetism to build up to full voltage, the field flash circuit 306 may inject a “field flashing” current (e.g., a current sufficient to generate the magnetic field to activate the genset 100) into the rotor 136 through the voltage regulator 301. After the engine 120 is started and the rotor 136 is up to speed, the AC output of the generator 130 is fed up to the voltage regulator 301 via an electrical line 302. The voltage regulator 301 then provides the field current to the rotor 136 via a positive voltage line 303 and a negative voltage line 304. A diode 305 may provide one-way communication between the positive voltage line 303 and the negative voltage line 304 and prevent flow of current in a reverse direction. In some embodiments, the voltage regulator 301 may comprise a “feed-forward” design. In other embodiments, the voltage regulator 301 may include negative feedback control loops, or any suitable design. The voltage regulator 301 may use electromechanical mechanism, electronic components, or any suitable components.

The field flash circuit 306 may inject a “field flashing” current into the rotor 136 through the voltage regulator 301 in a starting sequence. In particular, the field flash circuit 306 may receive power from a power source 307. In some embodiments, the power source 307 may be the battery 125 which provides a 12 VDC. The battery 125 may be coupled to the positive voltage line 303 via a diode 309. In some embodiments, the power source 307 may be external to the genset 100, for example, a house unit providing DC current, an AC utility power source, or any suitable power source. In situations where the power source 307 is an AC power source or a DC source that requires conversion of output voltage, a converter/inverter 308 may be disposed between the power source 307 and the diode 309. When the engine 120 is started, if the rotor 136 does not have enough residual magnetism to build up to full voltage, the field flash circuit 306 may inject a “field flashing” current into the rotor 136 via the positive voltage line 303.

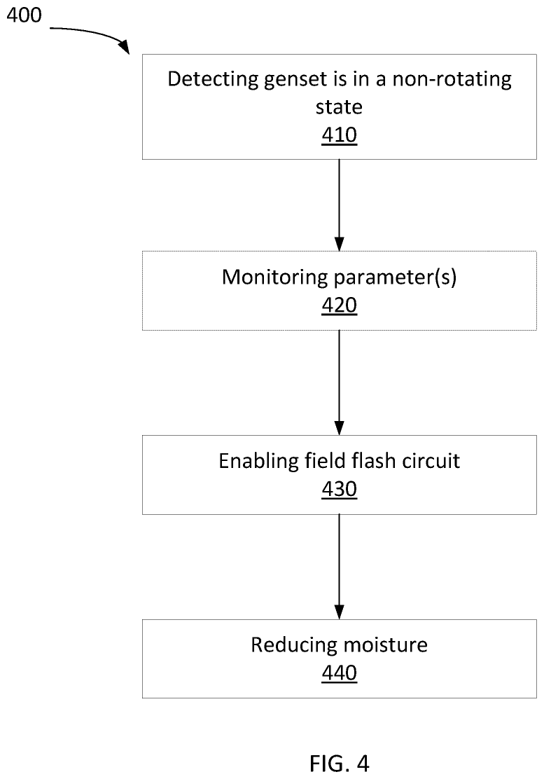

The field flash circuit 306 may also be used as an integrated alternator heater to drive off moisture for the generator 130. In particular, in some embodiments, the field flash circuit 306 may be in a continuous on state in the Auto/Remote mode to heat the generator 130. In some embodiments, the field flash circuit 306 is selectively enabled based on the time of a day, the temperature, the humidity, etc. The process will be discussed in detail below, according to some implementations, in combination with FIG. 4. The field flash circuit 306 and the voltage regulator 301 are shown in FIG. 1 to be integrated into the controller 300. In some embodiments, the field flash circuit 306 and the voltage regulator 301 may be separate components.

The processing system 310 may enable/disable the field flash circuit 306 (e.g., connect/disconnect the power source 307 to the positive voltage line 303) by, for example, controlling component(s), such as the on/off state of a switch (e.g., a FET), in the field flash circuit 306. The processing system 310 may include a processor 312 and a memory 314. The processor 312 may be implemented as a general-purpose processor, an application specific integrated circuit (ASIC), one or more field programmable gate arrays (FPGAs), a digital signal processor (DSP), a group of processing components, or other suitable electronic processing components. The memory 314 may be one or more memory devices (e.g., RAM, ROM, flash memory, hard disk storage, etc.) that stores data and/or computer code for facilitating the various processes described herein. The memory 314 may be communicably connected to the processor 312 and provide computer code or instructions to the processor 312 for executing the processes described herein. Moreover, the memory 314 may be or include tangible, non-transient volatile memory or non-volatile memory. The memory 314 may include database components, object code components, script components, or any other type of information structure for supporting the various activities and information structures described herein.

Although the processing system 310 is implemented as the processor 312 and memory 314 in the embodiment shown in FIG. 3, in other embodiments, the processing system 310 may be implemented as dedicated hardware such as circuitry.

It shall also be appreciated that the configuration of the controller 300 shown in FIG. 3 is provided for purposes of illustration only. Other embodiments may include fewer, more, or different components than those illustrated in FIG. 3. For example, the field flash circuit 306 and the voltage regulator 301 may be separate components from the controller 300.

Referring to FIG. 4, a flow chart 400 for operating a genset is shown according to an exemplary embodiment. The flow chart may be implemented on the genset 100 and components shown in FIGS. 1-3.

At an operation 410, the controller 110 detects that the genset 100 is not running, or in a non-rotating state. In some embodiments, the controller 110 detects that the genset 100 is in the Auto (or Remote) mode. In particular, the Auto/Remote mode can be selected manually by a user moving the rocker switch 201 on the control panel 200 to a bottom position 204. In the Auto/Remote mode, operation of the genset 100 may be activated and/or deactivated automatically in response to one or more monitored conditions. For example, electrical power provided by a utility may be monitored, and, if the commercial electrical power from the utility fails, the engine 120 of the electrical generator may be automatically started causing the generator 130 to generate electrical power. When the electrical power generated by the genset 100 reaches a predetermined voltage, a transfer switch may switch a load to the genset 100 from utility power lines. In some embodiments, the Auto/Remote mode may additionally or alternatively allow activation and/or deactivation of the genset 100 in response to a signal received from a location remote from the genset 100 (e.g., from a remote device 150 such as a remote transfer switch, a mobile computing device, remote desktop computing device, etc.). If the controller 110 receives a start signal from the remote device 150 (e.g., a transfer switch or a mobile computing device), the genset 100 may be started. If the controller 110 receives a stop signal from the remote device 150, the genset 100 may be shut down.

At an optional operation 420, the controller 110 monitors one or more parameters of the genset 100. For example, the controller 110 may monitor the time of day through the clock 160, the temperature of one or more components of the genset 100 (e.g., a real-time temperature) through the thermometer 162, and/or the humidity near one or more components of the genset 100 (e.g., a real-time humidity) through the humidity sensor 164. The temperature/humidity may be those of the environment, the windings, the alternator assembly, etc. In some embodiment, a resistance of the windings may be monitored and the temperature of the windings can be inferred from the resistance. In some embodiments, the controller 110 is configured to receive a local weather forecast via Internet. In some embodiments, a condition of the battery 125 may be monitored.

At an operation 430, the controller 110 enables the field flash circuit 306. In some implementations, the field flash circuit 306 is activated manually, and provides a heat source to drive off moisture for the generator 130 when the genset 110 is in a non-rotating state and that the “Reduce Moisture” button 205 on the operator panel 200 is pressed. In some implementations, the field flash circuit is activated in response to a command for reducing moisture received from the remote device 150. In some implementation, the field flash circuit 306 is activated when the Auto/Remote mode is enabled. When the genset 100 is activated automatically or remotely, the field flash circuit 306 may be disabled. When the genset is switched to the Start mode or the Off mode, the field flash circuit 306 may be disabled.

In some embodiments, the processing system 310 may selectively enable the field flash circuit 306 when the genset 100 is in the Auto mode based on various parameters such as a time of day, the temperature, the humidity, etc. For example, the field flash circuit 306 may be enabled in the early morning and/or the evening every day and disabled the rest of the day. The field flash circuit 306 may be enabled when the real-time temperature is lower than 60 Fahrenheit degree and disabled when the temperature is higher than 70 Fahrenheit degree. The field flash circuit 306 may be enabled when the real-time humidity is higher than 60 percent and disabled when the humidity is lower than 40 percent. The temperature/humidity may be those of the environment, the windings, the alternator assembly, etc. In some implementations, the field flash circuit 306 monitors a humidity and automatically triggers a demoisturization cycle and/or determines a frequency of a moisture reduction operation based on the monitored humidity. For example, the field flash circuit 306 monitors a sliding window of humidity over a timeframe (e.g., a sliding window of average humidity over the past several days) and determines when to activate moisture reduction and/or how frequently to activate moisture reduction in response to whether the monitored humidity exceeds a threshold, in some embodiments. In another example, the field flash circuit may monitor humidity or other parameters for spikes, such as by comparing measured humidity values to a threshold and activating moisture reduction if the humidity values exceed a threshold and/or by monitoring a rate of change of humidity over a timeframe and activating moisture reduction if the rate of change of humidity is above a threshold rate of change (e.g., indicating a rapid increase in humidity). In some embodiments, the controller 110 stores the location of the genset, and is configured to receive a local weather forecast via the Internet. The field flash circuit 306 is enabled/disabled based on the received weather forecast.

In some embodiments, a resistance of the windings may be monitored and the temperature of the windings can be inferred from the resistance. The field flash circuit 306 may be enabled/disabled based on the resistance. In some embodiments, a condition of the battery 125 may be monitored. The field flash circuit 306 is enabled/disabled based on the battery condition. For example, if the battery is low, the field flash circuit 306 may be disabled. The examples provided herein are given for illustration, and other parameters may be used to automatically enable and/or disable the field flash circuit 306 in various implementations. In some implementations, the various parameters described above, such as temperature and/or humidity, may be used to modulate the current applied to reduce moisture (e.g., change a level/amount of current applied) instead of or in addition to determining whether and how frequently to apply the current.

At an operation 440, the controller 110 facilitates reducing moisture on at least a portion of the genset 110 (e.g., the stator 134, the rotor 136, etc.) by applying the field flashing current using the integrated field flash circuit 306. In particular, the flow of the flashing current raises the temperature of at least a portion of the alternator and drives moisture out of the alternator.

The application of current to portions of the genset 110 to reduce moisture may be accomplished in a variety of ways. In some embodiments, an on/off cycle circuit for a DC rotor feed may be utilized to control application of current to the rotor 136 to reduce moisture. In some embodiments, a pulse width modulation (PWM) control may be utilized, using the on/off cycle circuit or another power control device, to control the application of current to the genset 110. For example, a PWM control scheme may be utilized to vary a width of current activation pulses to cause a desired current application, such as a sine-like applied current. Various other methods for applying current to reduce moisture may be utilized in other embodiments.

While various example embodiments discussed above reference utilizing a DC current to reduce moisture, in some embodiments, an AC current may additionally or alternatively be used to heat a portion of the genset 110 to reduce moisture. For example, an AC current may be applied to the stator 134 and/or rotor 136 to reduce moisture. In some implementations, cores of the stator 134 and/or rotor 136 may be manufactured from multiple layers of laminated metals (e.g., steel), and application of an AC current to the laminations may induce eddy currents in the laminations. The eddy currents generate heat in the laminations that reduces moisture in the genset 110. In some implementations, the AC current may be obtained from a utility source connected to the genset 110.

In some embodiments, the stator 134 coils may be heated to reduce moisture instead of or in addition to the rotor 136. For example, transistors on the different phases of the stator 134 may be driven to heat the associated coils of the stator 134 and reduce moisture. In some implementations, the stator 134 coils may be heated using AC power received from a utility or other power source to which the genset 110 is coupled.

In some implementations, materials utilized in the genset 110 (e.g., the stator 134 and/or rotor 136) may be designed to help prevent corrosion. For example, a portion of the genset 110 may be designed with multiple metallic materials, and a galvanic potential of the materials may be designed to that at least a portion of the genset 110 is resistant to corrosion, in combination with the heating techniques described herein. In some embodiments, one of the metals utilized in the design may be a sacrificial metal that is more reactive, such that it corrodes instead of, or at a faster rate than, the other metal in the presence of moisture. In some embodiments, materials used in the brush contacts and/or materials applied to the brush contacts may be designed to prevent corrosion of the contacts.

While various examples provided herein discuss reducing moisture in relation to applying a field flashing current, it should be understood that the present disclosure contemplates reducing moisture in a genset using any source of power. For example, in any of the examples above discussing application of field flashing current to reduce moisture, the field flashing current could be replaced with a different source of current (e.g., DC current), such as an external power source. All such modifications are contemplated within the scope of the present disclosure.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

While this specification contains specific implementation details, these should not be construed as limitations on the scope of any inventions or of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in a particular order, this should not be understood as requiring that such operations be performed in the particular order shown or in sequential order, or that all operations be performed, to achieve desirable results. Moreover, the separation of various aspects of the implementation described above should not be understood that the described methods can generally be integrated in a single application or integrated across multiple applications.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

1. A method comprising:
detecting that a generator set is in a non-rotating state, the generator set comprising a field flash circuit and an alternator structured to be operatively connected to an engine;
enabling the field flash circuit of the generator set to operate while the generator set is in the non-rotating state, wherein the field flash circuit is structured to provide a field flash current to the generator set;
activating the field flash circuit in a heating function so that current flows through and heats at least a portion of the alternator of the generator set and reduces a moisture on the at least a portion of the generator set; and
disabling the heating function of the field flash circuit in response to at least one of:
detecting that the generator set is in a first mode and is being activated, the first mode comprising:
a remote mode in which the generator set activates in response to receiving a signal from a device remote from a location of the generator set;
detecting that the generator set is switched to a second mode in which the generator set is activated manually; or
detecting that the generator set is switched to a third mode in which the generator set is turned off manually.

2. The method of claim 1, wherein the heating function of the field flash circuit is disabled in response to detecting that the generator set is in the first mode and is being activated.

3. The method of claim 1, wherein the heating function of the field flash circuit is disabled in response to detecting that the generator set is switched to the second mode in which the generator set is activated manually.

4. The method of claim 1, wherein the heating function of the field flash circuit is disabled in response to detecting that the generator set is switched to the third mode in which the generator set is turned off manually.

5. The method of claim 1, wherein enabling the field flash circuit of the generator set to operate while the generator set is in the non-rotating state comprises:
monitoring one or more parameters comprising at least one of a time of day, an environmental temperature, a temperature of the windings of the generator set, a temperature of an alternator assembly of the generator set, an environmental humidity, a humidity of the windings, a humidity of the alternator assembly, a resistance of the windings, a condition of a battery of the generator set, or a local weather forecast received over a network; and
selectively enabling or disabling the field flash circuit based at least in part on the monitored parameters.

6. The method of claim 1, wherein enabling the field flash circuit of the generator set to operate while the generator set is in the non-rotating state comprises selectively enabling or disabling the field flash circuit in response to a command received from the device remote from the location of the generator set.

7. The method of claim 1, further comprising applying an alternating current from a source external to the generator set to heat the at least a portion of the alternator and reduce the moisture.

8. A system, comprising:
circuitry configured to:
detect that a generator set is in a non-rotating state, the generator set comprising a field flash circuit and an alternator structured to be operatively connected to an engine;
enable the field flash circuit of the generator set to operate while the generator set is in the non-rotating state, wherein the field flash circuit is structured to provide a field flash current to the generator set;
activate the field flash circuit in a heating function so that current flows through and heats at least a portion of the alternator of the generator set and reduces a moisture on the at least a portion of the generator set; and
disable the heating function of the field flash circuit in response to at least one of:
detecting that the generator set is in a first mode and is being activated, the first mode comprising:
a remote mode in which the generator set activates in response to receiving a signal from a device remote from a location of the generator set;
detecting that the generator set is switched to a second mode in which the generator set is activated manually; or
detecting that the generator set is switched to a third mode in which the generator set is turned off manually.

9. The system of claim 8, wherein the heating function of the field flash circuit is disabled in response to detecting that the generator set is in the first mode and is being activated.

10. The system of claim 8, wherein the heating function of the field flash circuit is disabled in response to detecting that the generator set is switched to the second mode in which the generator set is activated manually.

11. The system of claim 8, wherein the heating function of the field flash circuit is disabled in response to detecting that the generator set is switched to the third mode in which the generator set is turned off manually.

12. The system of claim 8, wherein the circuitry is configured to enable the flash circuit by:
monitoring one or more parameters comprising at least one of a time of day, an environmental temperature, a temperature of the windings of the generator set, a temperature of an alternator assembly of the generator set, an environmental humidity, a humidity of the windings, a humidity of the alternator assembly, a resistance of the windings, a condition of a battery of the generator set, or a local weather forecast received over a network; and
selectively enabling or disabling the field flash circuit based at least in part on the monitored parameters.

13. The system of claim 8, wherein the circuitry is configured to enable the field flash circuit by selectively enabling or disabling the field flash circuit in response to a command received from the device remote from the location of the generator set.

14. A generator set, comprising:
an alternator structured to be operatively connected to an engine;
a field flash circuit structured to provide a field flash current to the generator; and
a controller configured to:
detect that the generator set is in a non-rotating state;
enable the field flash circuit to operate while the generator set is in the non-rotating state;
activate the field flash circuit in a heating function so that current flows through and heats at least a portion of the alternator of the generator set and reduces a moisture on the at least a portion of the generator set; and
disable the heating function of the field flash circuit in response to at least one of:
detecting that the generator set is in a first mode and is being activated, the first mode comprising:
a remote mode in which the generator set activates in response to receiving a signal from a device remote from a location of the generator set;
detecting that the generator set is switched to a second mode in which the generator set is activated manually; or
detecting that the generator set is switched to a third mode in which the generator set is turned off manually.

15. The generator set of claim 14, further comprising an operator panel, wherein the first mode is selected through the operator panel.

16. The generator set of claim 14, further comprising a clock structured to maintain the time of day, wherein the controller is configured to enable the field flash circuit based on the time of day.

17. The generator set of claim 14, further comprising a thermometer structured to measure an environmental temperature, a temperature of the windings of the generator set, or a temperature of an alternator assembly of the generator set, wherein the controller is configured to enable the field flash circuit based on the measured temperature.

18. The generator set of claim 14, further comprising a humidity sensor structured to measure an environmental humidity, a humidity of the windings, a humidity of an alternator assembly of the generator set, wherein the controller is configured to enable the field flash circuit based on the measured humidity.

19. The generator set of claim 14, further comprising a communication interface structured to receive a local weather forecast over a network, wherein the controller is configured to enable the field flash circuit based on the received local weather forecast.
